(19) United States
(12) Patent Application Publication
(10) Pub. No.: US 2005/0281956 A1
(43) Pub. Date: Dec. 22, 2005

(54) Thermal spraying method for manufacturing anti-sliding plate

(76) Inventors: Chia-Hua Chang, Longtan Township (TW); Jen-Chin Wu, Longtan Township (TW); Jin-Bao Liu, Longtan Township (TW)

Correspondence Address: RABIN & BERDO, P.C., Suite 500, 1101 14 Street, N.W., Washington, DC, 20005, US

(21) Appl. No.: 10/870,145

(22) Filed: Jun. 18, 2004

(51) Int. Cl. B05D 1/08

(52) U.S. Cl. 427/446

(57) ABSTRACT

A thermal spraying method is provided for manufacturing anti-sliding plates. The method uses a mask located upon a plate with a specific height. The mask has plural openings of a specific shape. When a thermal spraying device thermal-sprays thread material from the upper side of the mask, melted thread material passes through the openings to form anti-sliding spots of a specific shape on the plate. By means of thermal spraying on the mask with the openings, an anti-sliding plate with high roughness is efficiently produced.

### BACKGROUND OF THE INVENTION

1. Field of Invention

The invention relates to a thermal spraying method for manufacturing an anti-sliding plate and, in particular, to a method producing high wear-resistant and high heat-resistant anti-sliding plates of various roughnesses.

2. Related Art

In the prior art, methods for manufacturing an anti-sliding plate mainly include applying polymeric anti-sliding lacquer (for example, epoxy resin), and thermal spraying metal or nonmetal directly on a plate. Said lacquer applying technology has very limited usage due to the low selectiveness of materials, the difficulties of construction and repair, and short lifespan.

Thermal spraying technology has advantages of fast producing and no need for curing. The wear-resistant performance of a thermal spraying product is 5 times better than a lacquer applying product. Besides, the thermal spraying product is 14% lighter than the lacquer applying product. However, conventional anti-sliding plates only have slight roughness. For instance, the arc thermal spraying, aluminum (Al) anti-sliding plates used on the US Navy naval vessels have little roughness of 200˜300 μm (Proceedings Of The 1993 National Spray Conference, pp. 445-450).

Therefore, it is necessary to provide a new manufacturing technology for anti-sliding plates to solve the problems of the conventional thermal spraying method.

### SUMMARY OF THE INVENTION

In view of the foregoing, an objective of the invention is to provide a new thermal spraying method for producing an anti-sliding plate with high roughness.

To achieve the above objective, the disclosed method comprises the following steps. (a) Provide a plate. The plate is selectively of metal, for example iron (Fe), aluminum (Al) or zinc (Zn), or of plastic such as ABS, PP or PE. (b) Provide a mask located upon the plate with a specific height between 0.1-10 mm. And 1˜3 mm is better. The mask has plural openings. Each of the openings has a curvature radius less than 0.5 mm. (c) Provide a thread material. The thread material is selectively of metal such as aluminum (Al), molybdenum, tin (Sn), zinc (Zn), nickel (Ni), nickel alloy or stainless steel, or of nonmetal such as ceramics or ceramic metal. (d) Thermal-spray the thread material from the upper side of the mask by an arc thermal spraying device or a flame thermal spraying device to deposit the thread material through the openings of the mask to the plate under the mask to form a anti-sliding plate with plural anti-sliding spots.

The invention can effectively control the height, the amount and the distribution of the anti-sliding spots by using the mask to make a partial area of the plate without depositing the melt thread material. Moreover, anti-sliding plates of various roughnesses can be provided by adjusting the distance between the mask and the plate, the shape and size of the openings of the mask, the thermal-spray distance and the feeding speed of the thread material.

### BRIEF DESCRIPTION OF THE DRAWINGS

The invention will become more fully understood from the detailed description given hereinbelow illustration only, and thus are not limitative of the present invention, and wherein:

FIG. 1 shows the method of fabricating cone-shaped anti-sliding spots according to the invention; and

FIG. 2 shows the method of fabricating rectangular-shaped anti-sliding spots according to the invention.

### DETAILED DESCRIPTION OF THE INVENTION

### Embodiment 1

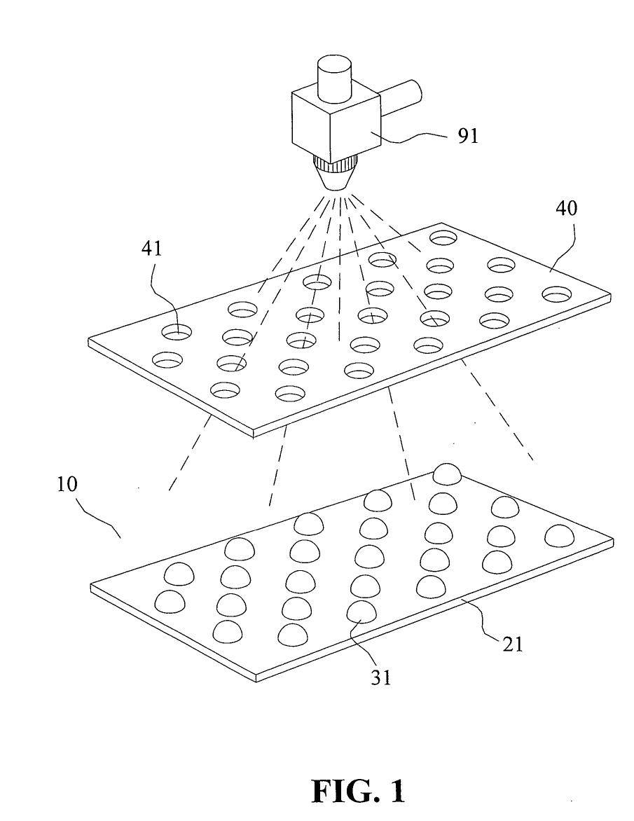

Please refer to FIG. 1, which shows an explanatory drawing for fabricating cone-shaped anti-sliding spots according to the invention. In this embodiment, a stamped porous mask 40 is positioned upon a metal (Fe) plate 21 with a distance of 2 mm. The stamped porous mask 40 has plural circular openings 41. Each of the circular openings 41 has a radius of 1,000 μm. An aluminum thread is used in this embodiment as the thread material. By using a flame thermal spraying device 91 located on the upper side of the stamped porous mask 40 with a distance of 25 cm, the aluminum thread is fed for melting in a speed of 250 cm/min for 5 minutes. Then, the melted aluminum thread is sprayed through the circular openings 41 to deposit on the plate 21 and form plural aluminum anti-sliding spots under the stamped porous mask 40. The roughness is 2,000 μm (Rmax), measured by Dial Depth Gauge. The anti-sliding plate 10 obtained in this embodiment has advantages of erosion-resistant and low price, and is capable of applying on steel-constructed platforms, aviation decks, side walks and operation areas for workers.

### Embodiment 2

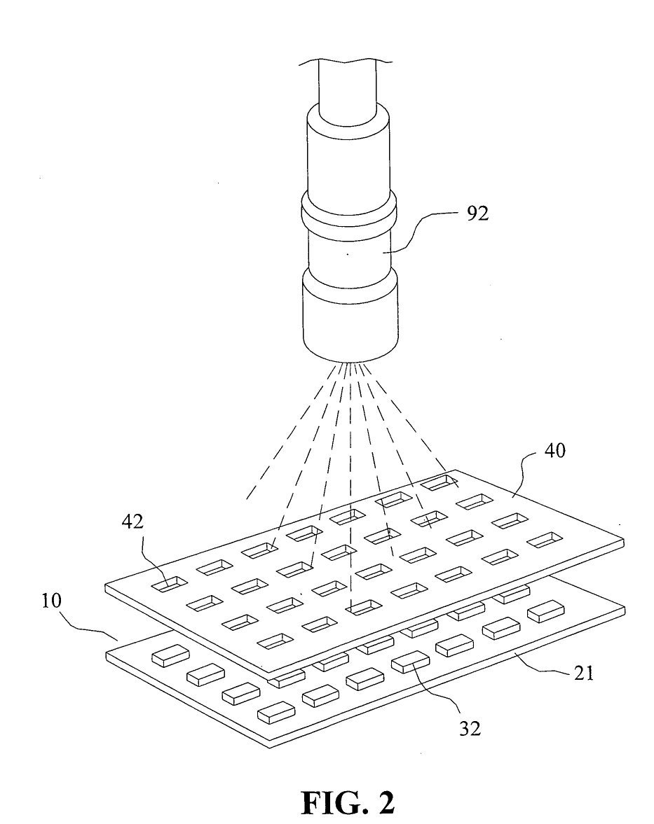

Please refer to FIG. 2, which shows an explanatory drawing for fabricating rectangular-shaped anti-sliding spots according to the invention. The difference between embodiments 1 and 2 is that the stamped porous mask 40 has plural rectangular openings 42. Each of the rectangular openings 42 has a side length of 2,000 μm. The stamped porous mask 40 is still positioned upon the iron (Fe) plate 21 with a distance of 2 mm. An arc thermal spraying device is used in this embodiment to thermal-spray molybdenum (Mo) thread to form an anti-sliding plate 10 with Mo anti-sliding spots 32 thereon. The measured roughness is 2,000 μm (Rmax). The anti-sliding plate 10 obtained in this embodiment has wear-proof, heat-resistant and erosion-resistant advantages, and is capable of applying on missile launching areas, aviation decks and flame-blocking areas for maneuver launching vehicles.

### Embodiment 3

This embodiment is almost the same as embodiment 2. The stamped porous mask 40 is still positioned upon the iron (Fe) plate 21 with a distance of 2 mm. The only difference is that a stainless steel thread is used and the measured roughness is 2,000 μm (Rmax). The anti-sliding plate 10 obtained in this embodiment has an excellent wear-proof advantage to have various applications in broad scopes.

### Embodiment 4

This embodiment is almost the same as embodiment 2. The only difference is that an ABS plastic plate and a zinc (Zn) thread with low melt point are used and the measured roughness is 2,000 μm (Rmax). The anti-sliding plate obtained in this embodiment is capable of applying as anti-sliding ground bricks.

According to the thermal spraying method of manufacturing anti-sliding plate disclosed in the invention, the stamped porous mask 40 is used to make a partial area of the plate 21 without depositing the melt thread material. Therefore, it is very easy to produce anti-sliding plates with the roughness of more than 3001 μm, even 2,000 μm. Besides, the amounts and the distributions of anti-sliding spots 31 and 32 can be controlled in very efficient way.

Certain variations would be apparent to those skilled in the art, which variations are considered within the spirit and scope of the claimed invention.

1. A thermal spraying method for manufacturing a anti-sliding plate, comprising the steps of:
(a) providing a plate;
(b) providing a mask located upon the plate with a specific height, the mask having a plurality of openings;
(c) providing a thread material; and
(d) thermal-spraying the thread material from the upper side of the mask to deposit the thread material through the openings of the mask to the plate under the mask to form the anti-sliding plate with a plurality of anti-sliding spots.

2. The method of claim 1, wherein the plate used in step (a) is a metal plate.

3. The method of claim 2, wherein the metal plate used in step (a) is made of iron (Fe), aluminum (Al) or zinc (Zn).

4. The method of claim 1, wherein the plate used in step (a) is a plastic plate.

5. The method of claim 1, wherein the mask used in step (b) is located upon the plate with a distance of 0.1-10 mm.

6. The method of claim 1, wherein the mask used in step (b) is located upon the plate with a distance of 1-3 mm.

7. The method of claim 1, wherein the opening of the mask used in step (b) has a minimum curvature radius of 0.5 mm.

8. The method of claim 1, wherein the thread material used in step (c) is a metal thread material.

9. The method of claim 8, wherein the metal thread material used in step (c) is made of aluminum (Al), molybdenum (Mo), tin (Sn), zinc (Zn), nickel (Ni), nickel alloy or stainless steel.

10. The method of claim 1, wherein the thread material used in step (c) is a nonmetal thread material.

11. The method of claim 10, wherein the nonmetal thread material used in step (c) is made of ceramics or ceramic metal.

12. The method of claim 1, wherein an arc thermal spraying device is used in step (d) to thermal-spray the thread material.

13. The method of claim 1, wherein a flame thermal spraying device is used in step (d) to thermal-spray the thread material.
